(19) United States
(12) Patent Application Publication
(10) Pub. No.: US 2004/0214682 A1
(43) Pub. Date: Oct. 28, 2004

(54) Dual stage differential speed transmission

(76) Inventor: Thomas L. Sbabo, Hamden, CT (US)

Correspondence Address: CARLSON, GASKEY & OLDS, P.C., 400 WEST MAPLE ROAD, SUITE 350, BIRMINGHAM, MI, 48009, US

(21) Appl. No.: 10/424,608

(22) Filed: Apr. 28, 2003

(51) Int. Cl. F16H 48/06

(52) U.S. Cl. 475/220

(57) ABSTRACT

A differential speed transmission for varying the rotational speed of an input shaft relative to an output shaft wherein the differential speed transmission is characterized by: a pair of opposed first stage face gears each having a second stage pinion gear co-rotating therewith, a first stage input pinion disposed between and engaging each of the face gears to effect counter-rotation of the face gears and the second stage pinions, and a second stage face gear engaging each of the second stage pinions for driving the output shaft.

In one embodiment of the invention, the second stage face gear circumscribes a portion of the first stage face gears and a base portion of said output shaft envelopes a portion of the first stage face gears. This arrangement permits large speed differentials within a small, compact design envelop. In another embodiment, the differential speed transmission permits alignment of the face gear pair about a common axis to effect equal torque distribution. One embodiment permits self-adjustment of the face gear pair and another embodiment permits independent manual adjustment of each.

### TECHNICAL FIELD

This invention relates to a transmission arrangement and, more particularly, to a differential speed transmission incorporating two parallel, opposed face gears for effecting significant speed differential, and still more particularly to such differential speed transmission wherein the face gear arrangement facilitates equal load sharing across two branchs of the differential speed transmission.

### BACKGROUND OF THE INVENTION

Transmissions are utilized in operating machinery (e.g., aircraft, automotive, hand tools) to provide reduction or augmentation of the speed provided by an engine. Typically, electric motors, internal combustion engines, and turbine engines operate efficiently and produce maximum power when operating at high rotating speeds. The maximum motor or engine speed is usually significantly higher than the optimum speed for the machinery being driven. Accordingly, a reduction in the rotational speed output from the engine to the machinery being driven is typically required. The most common method for reducing the rotational speed output from an engine is through a gear train or transmission. For example, in a helicopter, turbine engines provide the rotational motion required to propel or drive the main rotors. The rotational output speed from a turbine engine is about 20,000 Revolutions Per Minute (RPM), yet the desired rotational speed of the main rotors is about 250 RPM. Accordingly, a significant reduction in rotational speed is required between the engine and the rotors in a conventional helicopter.

Many factors need to be taken into consideration when designing a transmission for use in an operating machine. For example, the size and weight of the transmission might govern the materials selected and the overall configuration of the transmission. Similarly, the location of the engine with respect to the transmission may determine the placement of the reduction stages. (A stage in a transmission is defined as a gear set where there is a reduction in speed.) As stated above, the amount and size of gearing needed to provide the requisite speed reduction has a significant impact on the resulting size of the transmission.

Additionally, the drive shafts that transmit the rotational speed to the driven component may be oriented at an angle relative to the drive shaft leading to the transmission from the engine. For example, referring to FIG. 1, a portion of a drive train for a helicopter is illustrated. An engine (not shown) drives an input bevel shaft at high rotational speed. The input bevel shaft is in rotational engagement with a quill shaft by means of a first arrangement of gears (first stage). The quill shaft, in turn, is engaged with a second arrangement of bevel gears (second stage). The bevel gear within the second stage is rotationally coupled to an epicyclic gear train. More specifically, the sun gear drives the main rotor shaft through an arrangement of planetary pinions disposed between the sun and a ring gear (third stage). In many situations the rotational axis of the input bevel shaft is at an angle other than perpendicular or parallel to the rotational axis of the main rotor shaft. For example, FIG. 2 illustrates a helicopter gear train which drives a main rotor mast or shaft and a tail rotor shaft. As shown, both the main rotor shaft and the tail rotor shaft are located at an angle to the input bevel shaft. The angular orientation of the input bevel shaft to the main and tail rotor shafts requires several complex reduction stages with associated intermediary shafts to transfer the rotational motion. For example, since the tail rotor shaft is located aft and above the input bevel shaft, a tail take-off, tail drive shaft, and intermediate and tail gearboxes are needed to transfer the rotational motion. Accordingly, a wide variety of gear arrangements may be needed in a transmission to vary the speed and transmit the torque that is required.

All the factors discussed above influence the resulting transmission configuration. As is illustrated in FIGS. 1 and 2, these factors may result in a transmission which is relatively large and complex with numerous interacting parts. Such a configuration is costly to produce and adversely impacts weight. Cost, reliability, and weight are the most important issues that must be considered in designing a transmission.

While the prior art methods for reducing transmission vibration provide a workable solution for existing complex transmissions, these systems can be costly and do not adequately reduce the size and complexity of the overall transmission.

An equally important design consideration is the loading on the various gears and gear teeth to ensure that tooth loading is equally distributed, and, therefore, minimized. More specifically, in highly-loaded transmission systems, and in particular, helicopter transmissions, it may be desirable to split the power output from an engine into two branches, thereby splitting the load equally to a common output member. This portion of the gear train is commonly referred to as the torque split module. Such split path transmission modules reduce the tooth loading of the intermeshing gears, i.e., gear train assemblies, and result in lighter weight gear train assemblies. In addition, split path transmission modules are inherently more reliable from the perspective that if one gear assembly, i.e., load path, becomes inoperative, the total torque from the respective engine will be transmitted through the remaining gear assembly, i.e., the redundant load path, thereby ensuring short-term emergency operation of the transmission system.

Ideally, a torque split transmission module should be designed to ensure that torque is split in equal proportions between the load paths of each torque transmitting branch. One skilled in the art will also recognize that by simply driving torque from a singular input gear to dual output gears does not inherently ensure that the torque will be equally distributed in an ideal manner between the output gears. The torque split, i.e., load sharing, between the split load paths of the respective torque transmitting branches will be a natural result or consequence of the relative gear tooth Hertzian deflections, gear tooth bending deflections, gear rim deflections, torsion and bowing of gear shafts, bearing deflections, and by housing deflections due to loading/thermal effects. These factors, individually or in combination, can cause torque loading differentials within the torque split transmission module.

In an attempt to minimize torque load differences between the split load paths of the module, the prior art has interposed a torque adjusting device within the torque load path between the engine and the central bull gear. One prior art torque adjusting device for split path transmission systems is a quill shaft as exemplarily illustrated in FIG. 3 of U.S. Pat. No. 5,113,713. Quill shafts provide a means for minimizing the torque loading differences between the split load paths by reducing the torsional spring rates of the load paths, which reduces the net effects of the factors that produce torque load differentials. While the use of quill shafts to reduce torsional spring rates is a relatively effective method, the method does not completely compensate for the factors causing the torque loading differences, but instead acts to minimize the net effect of such factors.

Therefore, the quill shaft method does not guarantee, and rarely achieves, the ideal condition of an equal distribution of torque between the forward and aft split load paths. Furthermore, incorporating a quill shaft in each gear train assembly increases the overall complexity and weight of the split path transmission system. This, in turn, increases the costs and time required for initial assemblage and subsequent maintenance of the transmission system. In addition, incorporation of quill shafts into the transmission system reduces the reliability of the system such that inspection and maintenance is required on a more frequent basis.

Yet another means to effect load sharing is disclosed in U.S. Pat. No. 5,117,202 wherein a ring of elastomer is interposed between the web and teeth of a spur gear. The elastomer, which is preloaded by means of a V-shaped bearing race, is soft in the tangential direction thereby permitting a small degree of wind-up of the gear teeth relative to the gear shaft. Two such load sharing gears are incorporated in the torque split transmission module, typically between the input pinion and each output pinion which drives the main bull gear. Wind-up of the gear teeth compensates for many of the factors which typically cause torque load differences. While this approach produces the desired load sharing effect, elastomer materials can degrade over time, especially when exposed to oils and elevated temperature as are always present in most high torque transmissions. Furthermore, this configuration adversely impacts the cost and weight of the transmission system.

A need therefore exists for a transmission arrangement which reduces the size and complexity thereof, thereby decreasing the cost and weight of the transmission. Further, a need also exists to provide a load sharing arrangement in a torque split transmission module that is operative to provide substantially equal torque distribution therein. Such a load sharing arrangement should achieve equal torque distribution without adversely impacting the weight, manufacturability, cost or complexity of the transmission system.

### DISCLOSURE OF THE INVENTION

It is the object of the present invention to provide a speed differential transmission that reduces the design envelope thereby reducing the weight and complexity of the transmission.

It is another object of the present invention to provide a speed differential transmission that achieves high reduction ratios for use in rotorcraft applications.

It is yet another object of the present invention to provide a speed differential transmission having a torque split arrangement which provides substantially equal torque distribution therein.

It is another object of the present invention to provide such a torque split transmission arrangement which provides load sharing via automatic or self-alignment of various gear train components.

These and other objects of the present invention are achieved by a differential speed transmission for varying the rotational speed of an input shaft relative to an output shaft. The differential speed transmission is characterized by: a) a pair of opposed first stage face gears each having a second stage pinion gear co-rotating therewith, b) a first stage input pinion disposed between and engaging each of the face gears to effect counter-rotation of the face gears and the second stage pinions, and c) a second stage face gear engaging each of the second stage pinions for driving the output shaft.

In one embodiment of the invention, the second stage face gear circumscribes a portion of the first stage face gears and a base portion of said output shaft envelopes a portion of the first stage face gears. This arrangement permits large speed differentials within a small, compact design envelop. In another embodiment, the differential speed transmission permits alignment of the face gear pair about a common axis to effect equal torque distribution. One embodiment permits self-adjustment of the face gear pair and another embodiment permits independent manual adjustment of each.

### BRIEF DESCRIPTION OF THE DRAWINGS

A more complete understanding of the present invention and the attendant features and advantages thereof may be had by reference to the following detailed description when considered in conjunction with the accompanying drawings wherein:

FIG. 1 is a perspective view of a gear train arrangement used in a helicopter transmission.

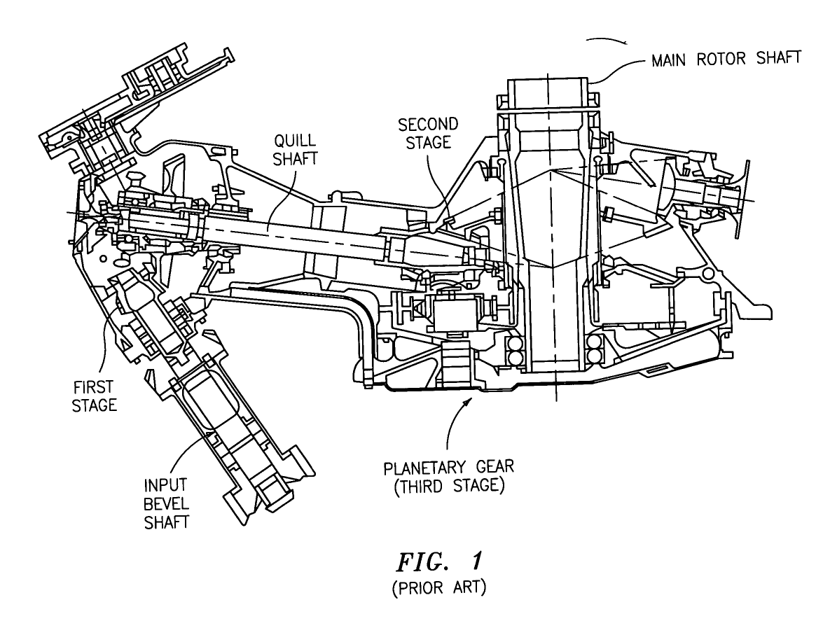

FIG. 2 illustrates a helicopter gear train which drives a main rotor mast or shaft and a tail rotor shaft.

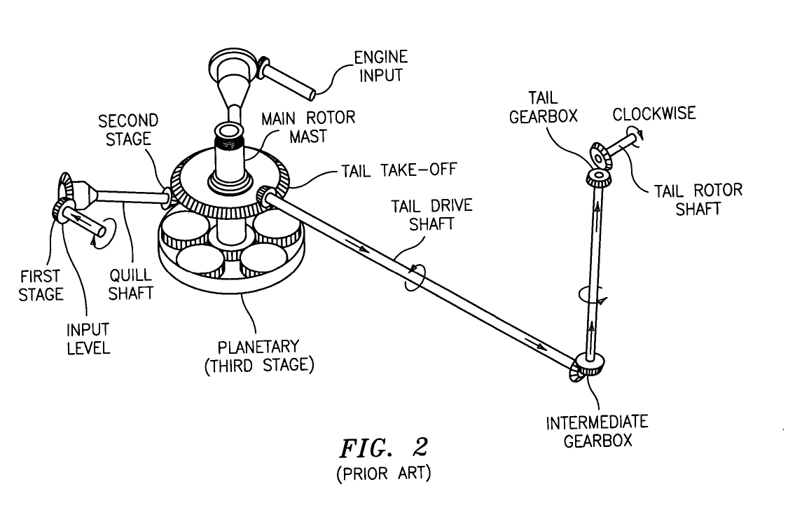

FIG. 3 is a top view of a dual stage differential speed transmission according to the present invention.

FIG. 4 is a cross-sectional view taken substantially along line 4-4 of FIG. 3.

FIG. 5 is a cross-sectional view taken substantially along line 5-5 of FIG. 3.

FIG. 6 is a cross-sectional view taken substantially along line 6-6 of FIG. 4.

FIG. 7 is a cross sectional view taken substantially along line 7-7 of FIG. 4.

FIG. 8 is a cross sectional view taken substantially along line 8-8 of FIG. 7.

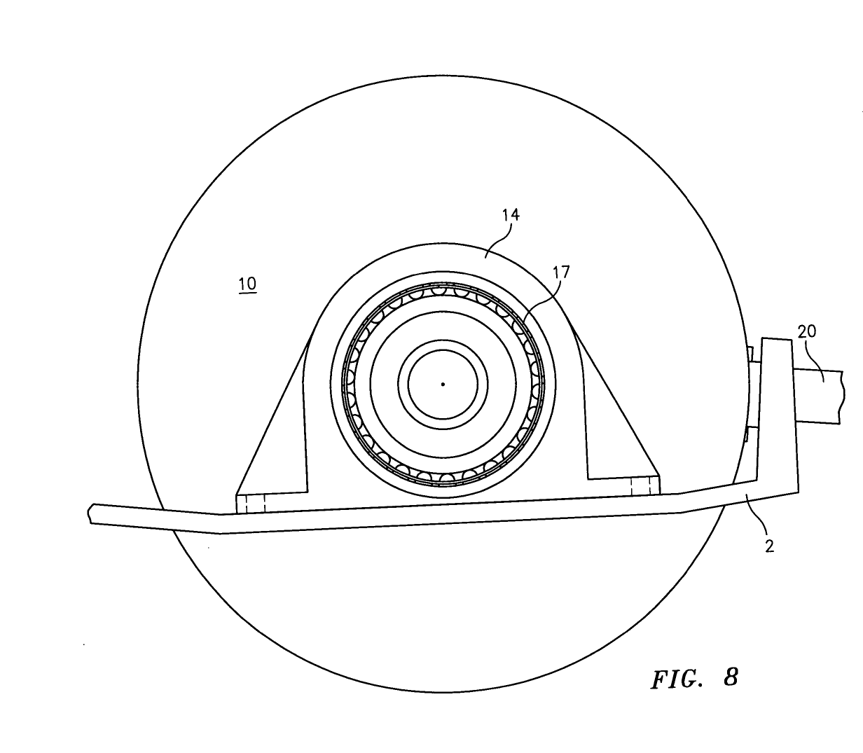

FIG. 9 is a cross sectional view taken substantially along line 9-9 of FIG. 4.

### BEST MODES FOR CARRYING OUT THE INVENTION

The dual stage differential speed transmission of the present invention is described in the context of a helicopter transmission having a single engine input, such as that employed in relatively simple compound helicopters or Vertical Take-Off and Landing (VTOL) Unmanned Aerial Vehicles (UAVs). One skilled in the art will appreciate that the present invention has utility for helicopters having other power plant system configurations, e.g., a power plant system composed of two or three engines, as well as for applications other than helicopter transmission systems. Moreover, while the differential speed transmission is described in the context of a speed reduction device, i.e., having a high speed input and a low speed output, it should be understood that the invention is equally applicable to devices which augment or increase speed, i.e., a low speed input to a high speed output. Therefore, it is to be understood that the following description of the dual stage differential speed transmission of the present invention is not intended to be limiting, but merely illustrative of the teachings according to the present invention.

In the description which follows, the term “gear” will generically apply to any rotating element that drives torque via a plurality of teeth. Furthermore, gears include pinions, however, pinions will generally refer to the smaller diameter gear of an intermeshing gear pair.

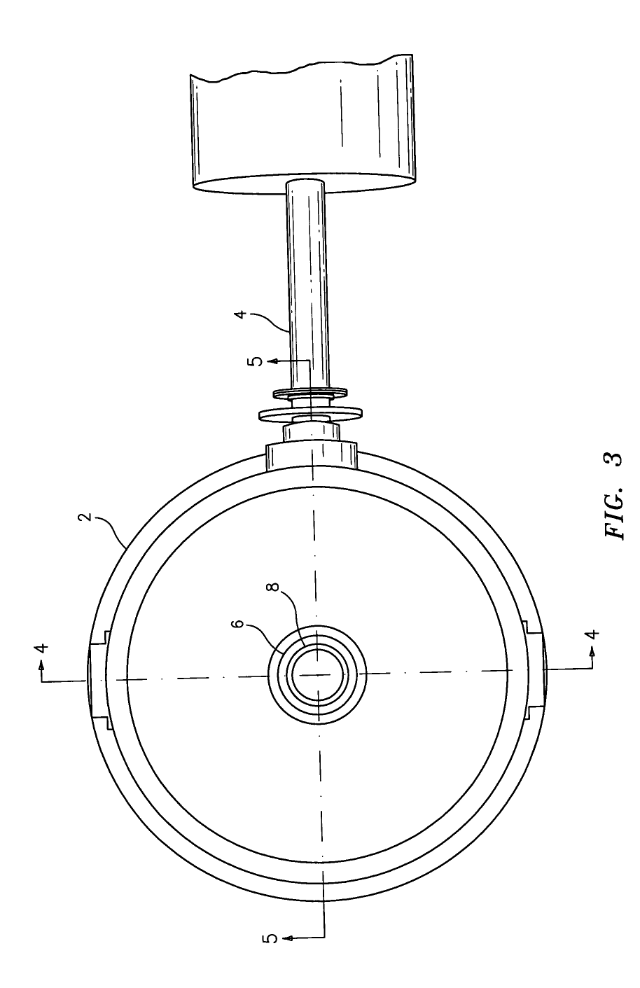

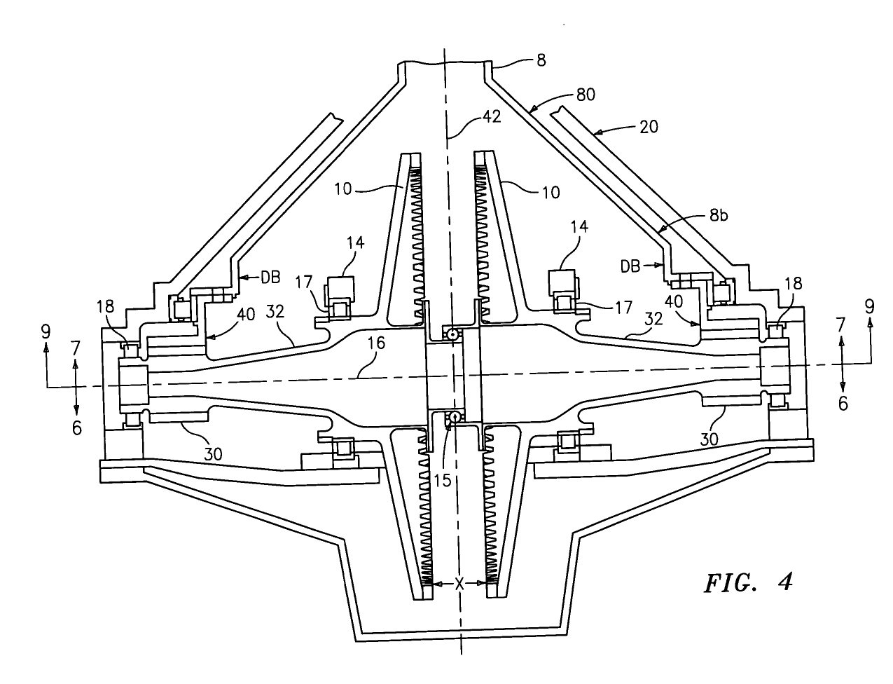

In FIG. 3, a helicopter gearbox is shown having a gearbox housing 2 for supporting and enveloping an internal drive train (shown in subsequent views). The gearbox 2 includes an aft input aperture (not shown in FIG. 3) for accepting an input drive shaft 4 and an upper output aperture 6 for accepting an output drive shaft 8. Referring to a rearward looking cross-sectional view illustrated in FIG. 4, the dual stage differential speed transmission of the present invention includes a pair of opposed first stage face gears 10 each being supported within the gearbox housing by a bearing mount assembly 14. The opposed face gears 10 are furthermore, substantially parallel to each other, are spaced-apart and share a common rotational axis 16. The opposed face gears 10 are axially coupled by means of a bearing 15 which permits relative rotation between each of the face gears 10 while, additionally establishing a maximum separation distance X therebetween. The two face gears 10 are otherwise mounted such that their position, as a unit, can vary in the direction of their common axis 16. In the described embodiment, this mounting arrangement comprises cylindrical roller bearings 17 and 18 which radially center the face gears while also permitting a small degree of axial displacement. This feature will become clear when discussing the operation of the transmission.

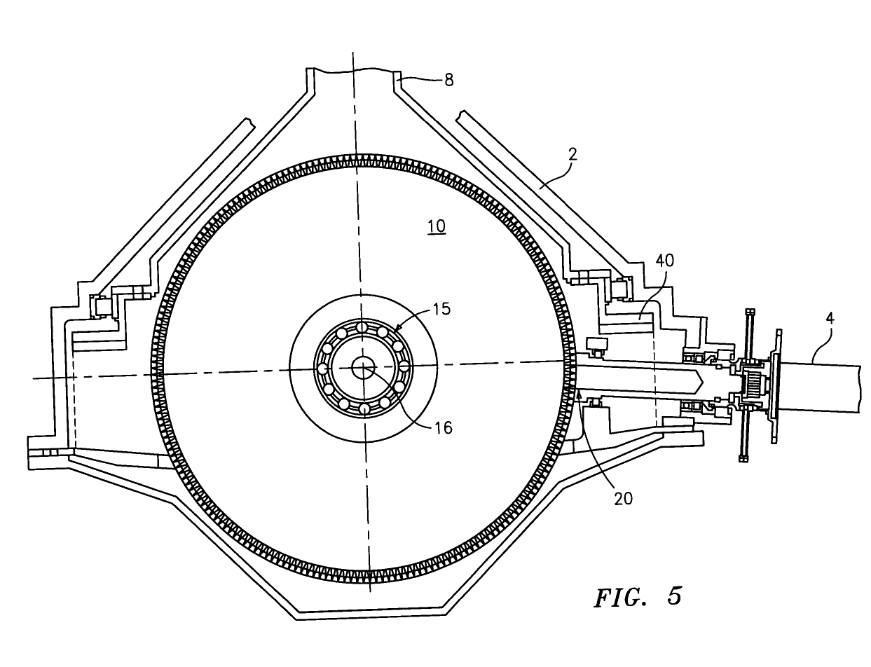

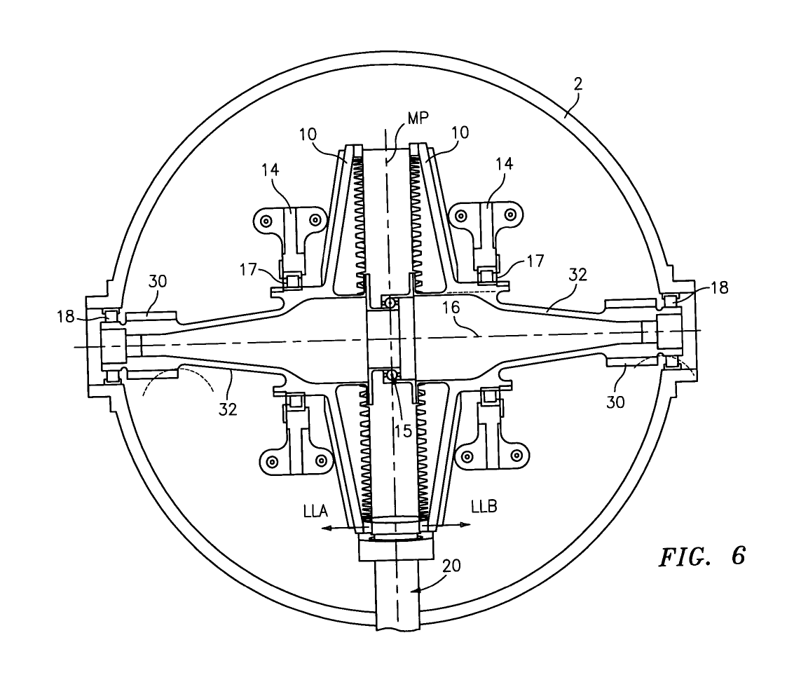

In FIGS. 5 and 6, a first stage input pinion 20 is disposed between the opposed face gears 10 and in intermeshing engagement with each such that the face gears 10 are driven in opposite directions, i.e., counter rotate. In the described embodiment, the first stage speed differential is about 6.9:1, wherein the first stage input pinion 16 turns at about 24000 Revolutions Per Minute (RPM) and each of the first stage face gears 10 rotates at about 3467 RPM. A second stage pinion 30 is co-axial and co-rotates with each of the face gears 10. In the described embodiment, each of the second stage pinions 30 is integral with each of the face gears 10, i.e., via integral shafts 32, however, the second stage pinions 30 may be coupled in any of a variety of ways, e.g., spline connected or via a sleeve coupling.

Moreover, each second stage pinion 30 is equidistant from and disposed on an opposing side of a medial plane MP defined by and between the face gears 10. That is, since the face gears 10 are essentially parallel and spaced apart, the medial plane MP is a plane that bisects the separation between the face gears 10.

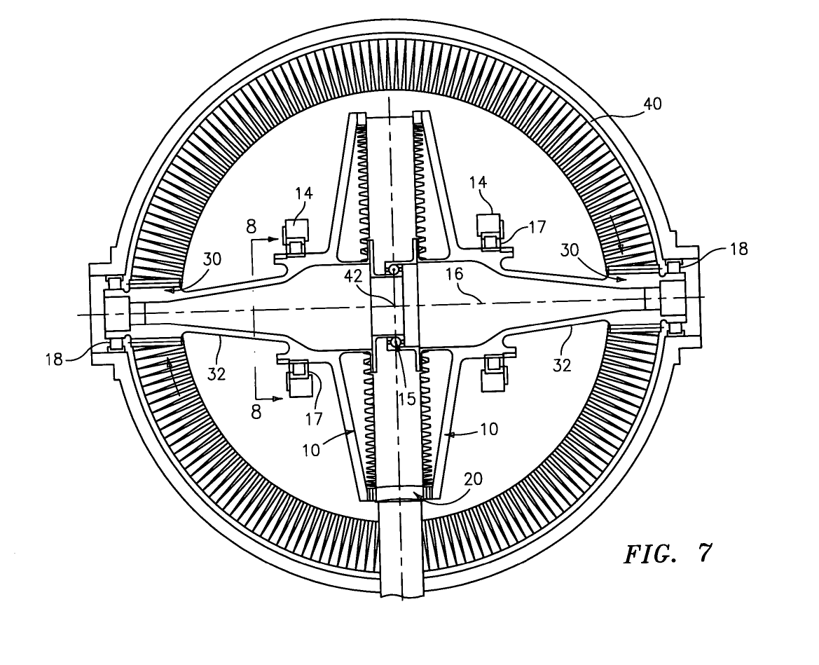

Inasmuch as the face gears 10 counter-rotate, the second stage pinions 30 also rotate in opposite directions. In FIG. 7, a second stage face gear 40 is disposed in intermeshing engagement with, and is driven by, the second stage pinions 30. Furthermore, the second stage face gear 40 rotates about an axis 42, also the output shaft axis, that is substantially orthogonal to the common rotational axis 16 of the second stage pinions 30. Moreover, the second stage face gear 40 circumscribes a portion, e.g., proximal to the center, of the opposed face gears 10,

Referring again to FIG. 4, the output drive shaft 8 is flange connected to and driven by the second stage face gear 40. Furthermore, to avoid interfering with an upper portion of the opposed face gears 10, the second stage face gear 40, envelopes the upper portion of the opposed face gears 10. That is, the diameter DB at the base 8b of the output drive shaft 8 is greater than its diameter at an upper portion thereof 8u. While the base 8b may define a variety of shapes, in the preferred embodiment, the base 8b of the output drive shaft 8 is frustoconically-shaped. Similarly, to minimize the envelope of the housing 2, its upper portion 2u may also have a complementary geometry, i.e., also frustoconically shaped.

In the described embodiment, the second stage speed differential ratio is also about 8.1:1, wherein the second stage input pinions 30 turn at about 3467 Revolutions Per Minute (RPM) and the second stage face gear rotates at about 429 RPM. Consequently, the total speed differential is about 55.9:1.

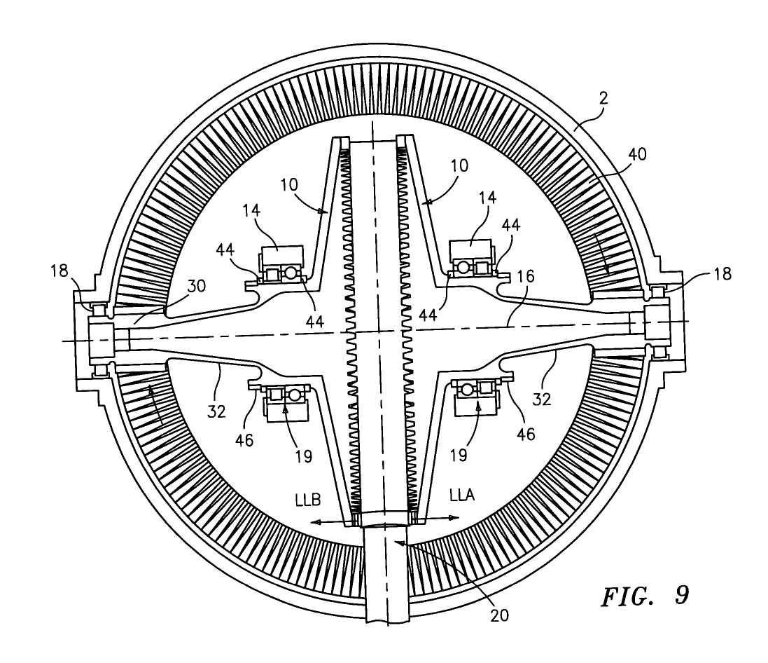

By examining the load paths created by the differential speed transmission of the present invention, it will be appreciated that the torque is bifurcated by the opposed first stage face gears 10 and converge, once again, at the single second stage face gear 40. Referring to FIGS. 6 and 9, the arrangement of the present invention facilitates load sharing by axial displacement of the face gear pair along axis 16. It will be appreciated that the high tooth loads developed between the input pinion 20 and the face gears 10 will develop lateral loads LLA, LLB, i.e., relative to the pinion 20, tending to separate the face gears 10. These separating loads LLA, LLB are proportional to the torque being transmitted by the gear mesh. If the mesh between the pinion 20 and one of the face gears 10 is more heavily loaded, the separating load LLA or LLB will be higher on that side of the input pinion. Inasmuch as, in the embodiment shown in FIG. 6, the face gears 10 are axially coupled, the gears 10 will be driven along axis 16 in the direction of the greater separating load until the two separating loads LLA, LLB, and therefore torque, are balanced.

In another embodiment depicted in FIG. 9, the face gears 10 are not coupled, but simply supported by roller/ball bearing 18, 19 within the housing 2. Furthermore, shims 44 are disposed on one or both sides of the roller/ball bearings 19. As such, the transmission error and/or gear mesh backlash may be measured and adjustments made by disposing shims 44 of varying width between the respective face gear 10 and the mount 14. When separating loads LLA, LLB are balanced, a nut 46 is used to fix the position of the shims 44 and roller/ball bearings 19.

In summary, it should be appreciated that the incorporation of face gears make both the dual stage speed differential and load sharing possible. With respect to speed reduction or augmentation, face gears are ideal for engaging small diameter pinions to effect large speed differentials therebetween. With respect to load sharing, face gears are particularly forgiving with respect to the radial position that, for example, an intermeshing spur gear contacts the teeth of the face gear. Additionally, faces gear 40 as shown in the present invention do not generate loads along axis 16. With respect to the transmission configuration of the present invention, it will be appreciated that by altering the axial position of one or both of the first stage face gears, the position of the second stage pinion is simultaneously altered. Inasmuch as face gears can tolerate such variations without significantly altering the tooth load distribution or causing other transmission errors, the tooth mesh between the second stage face gear 40 and the respective second stage pinion 30 is unaffected by the axial displacement of the face gears 10. In contrast, if an attempt were made to utilize a bevel gear mesh between, for example, the second stage pinion 30 and second stage face gear 50, for proper tooth meshing to occur, the apexes of each bevel gear must be coincident. Consequently, axial displacement of one of the first stage face gears 10 would necessarily alter this relationship and transmission errors would result.

Although the invention has been shown and described herein with respect to a certain detailed embodiment of a dual stage differential speed transmission, it will be understood by those skilled in the art that a variety of modifications and variations are possible in light of the above teachings. It is therefore to be understood that, within the scope of the appended claims, the present invention may be practiced otherwise than as specifically described hereinabove.

1. A differential speed transmission having rotating input and output shafts, said transmission having a housing for encasing and supporting an internal drive train for varying the rotational speed of the input shaft relative to the output shaft, said differential speed transmission further comprising:
a pair of opposed first stage face gears having a common axis of rotation and defining a medial plane;
an axial coupler between said pair of opposed first stage face gears to restrict axial movement of said pair of opposed first stage face gears along said common axis of rotation;
a second stage pinion co-rotating with each of said pair of opposed first stage face gears about said common axis of rotation, said second stage pinions being equidistant from said medial plane and disposed on opposite sides of said pair of face gears;
a first stage input pinion being driven by said input shaft, said input pinion being disposed between and engaging each of said pair of opposed first stage face gears to effect counter-rotation of said pair of opposed first stage face gears and said second stage pinions; and
a second stage face gear having an output axis which is substantially orthogonal to said common axis and engaging each of said second stage pinions for driving said output shaft.

2. The differential speed transmission according to claim 1 wherein said second stage face gear circumscribes a portion of said pair of opposed first stage face gears and wherein a base portion of said output shaft envelopes a portion of said first stage face gears.

3. The differential speed transmission according to claim 1 wherein said second stage face gear circumscribes a portion of said pair of opposed first stage face gears and wherein said base portion is frustoconical in shape.

4. The differential speed transmission according to claim 1 wherein said axial coupler permits axial displacement of at least one of said pair of opposed first stage face gears along said common axis of rotation to effect equal torque distribution to each of said pair of opposed first stage face gears.

5. The differential speed transmission according to claim 1 wherein each of said second stage pinions are integral with each of said respective pair of opposed first stage face gears.

6. The differential speed transmission according to claim wherein said second stage face gear circumscribes a portion of said pair of opposed first stage face gears and wherein a base portion of said output shaft envelopes a portion of said pair of opposed first stage face gears.

7. The differential speed transmission according to claim 5 wherein said second stage face gear circumscribes a portion of said pair of opposed first stage face gears and wherein said base portion is frustoconical in shape.

8. (CANCELLED)

9. (CANCELLED)

10. (CANCELLED)

11. (CANCELLED)

12. (CANCELLED)

13. The differential speed transmission according to claim 4 wherein said axial coupler establish a maximum separation distance been said pair of opposed first stage face gears, said pair of opposed first stage face gears translating as a unit to effect load sharing.

14. The differential speed transmission according to claim 13 wherein said second stage face gear circumscribes a portion of said pair of opposed first stage face gears and wherein a base portion of said output shaft envelopes a portion of said pair of opposed first stage face gears.

15. The differential speed transmission according to claim 14 wherein said second stage face gear circumscribes a portion of said pair of opposed first stage face gears and wherein said base portion is frustoconical in shape.

16. The differential speed transmission according to claim 15 wherein each of said second stage pinions are integral with each of said respective pair of opposed first stage face gears.

17. The differential speed transmission according to claim 1 wherein said second stage face gear circumscribes a portion of said pair of opposed first stage face gears and wherein a base portion of said output shaft envelopes a portion of said pair of opposed first stage face gears.

18. The differential speed transmission according to claim 1 wherein said axial coupler comprises a bearing which permits relative rotation between each of said pair of opposed first stage face gears.

19. The differential speed transmission according to claim 1 wherein said axial coupler is located on said medial plane.

20. The differential speed transmission according to claim 1 further comprising a hollow shaft interconnecting each of said second stage pinions with each of said respective pair of opposed first stage face gears.

21. A differential speed transmission comprising:
a pair of opposed first stage face gears having a common axis of rotation and defining a medial plane;
a bearing between said pair of opposed first stage face gears to provide a maximum separation distance between said pair of opposed first stage face gears along said common axis;
a second stage pinion co-rotating with each of said pair of opposed first stage face gears about said common axis of rotation, said second stage pinions being equidistant from said medial plane;
a first stage input pinion being driven by an input shaft, said input pinion meshingly engaged with each of said first stage face gears to effect counter-rotation of said first stage face gears and said second stage pinions; and
a second stage face gear having an output axis which is substantially orthogonal to said common axis and engaging each of said second stage pinions for driving an output shaft.

22. The differential speed transmission according to claim 21 further comprising a hollow shaft interconnecting each of said second stage pinions with each of said respective pair of opposed first stage face gears.

23. The differential speed transmission according to claim 21 wherein said bearing is located on said medial plane.
